(19) United States
(12) Patent Application Publication
(10) Pub. No.: US 2003/0209889 A1
(43) Pub. Date: Nov. 13, 2003

(54) Plastic emblem attachment method

(75) Inventors: Steven J. Erwin, Port Huron, MI (US); Patrick J. Fonk, Sterling Heights, MI (US)

Correspondence Address: BREED TECHNOLOGIES, INC, PATENT DEPARTMENT, 7000 NINETEEN MILE ROAD, STERLING HEIGHTS, MI, 48314

(73) Assignee: Breed Automotive Technology, Inc.

(21) Appl. No.: 10/401,992

(22) Filed: Mar. 28, 2003

Related U.S. Application Data
(60) Provisional application No. 60/379,913, filed on May 13, 2002.

(51) Int. Cl. B60R 21/20

(52) U.S. Cl. 280/728.3

(57) ABSTRACT

An air bag cover for an inflatable air bag system having an elastomeric body with a front surface and a rear surface, the body having a first aperture extending between the front and rear surfaces and a plurality of mounting pins or legs extending from the rear surface and located about the first aperture; and a badge assembly having a badge portion and a mounting rim about the badge portion, the badge portion fitting up through the first aperture from the rear surface, the rim extending under the rear surface proximate the first aperture with the legs disposed in at least some corresponding mounting opening in the rim. A light source within the cover can be provided to illuminate the badge.

This application claims the benefit of U.S. Provisional Application 60/379,913, filed on May 13, 2002. The disclosure of the above application is incorporated herein by reference.

### BACKGROUND AND SUMMARY OF THE INVENTION

The present invention relates to an air bag module having a decorative emblem and more particularly to a method of attaching the emblem to the module cover.

Many air bag modules and in particular driver air bag modules utilize a molded elastomeric cover with an emblem designating the manufacturer of the vehicle. U.S. Pat. No. 6,158,764 utilizes a decorative emblem having a plurality of extending tabs, which are received through complementary slots in the cover. The emblem is mounted to the cover from the top side of the cover with the extending tabs or legs passed through the slots and later bent over upon the underside of the cover. U.S. Pat. No. 6,149,186 illustrates another methodology for attaching an emblem or medallion to a cover in which a coined metal decorative badge or tab having extending pins wherein the ends of the pins are later formed into rivet-like connections holding the decorative badge to the cover. The coined metal badge can be replaced by a plastic badge with plastic extending legs, which are heat-staked to the bottom of the cover.

The present invention provides an improvement to tag technology and permits the decorative badge or emblem to be secured to the deployment cover of the module from the underside of the cover. The cover is constructed with a central opening defining the location of the badge. Positioned about the central opening of the cover is a plurality of integrally formed extending legs or pegs. The badge includes a like plurality of openings, which in combination with the cover legs or pegs, guide the emblem into position relative to the cover opening. The legs are thereafter formed into a rivet-like structure, holding the decorative badge/emblem/tag in place. One of the benefits of the present invention is the ability to illuminate a decorative badge/emblem/tag mounted in the manner claimed.

It is an object of the present invention to provide an improved decorative badge/cover arrangement.

Accordingly the invention comprises: an air bag cover for an inflatable air bag system comprising an elastomeric body with a front surface and a rear surface, the body including a first aperture extending between the front and rear surfaces and a plurality of mounting pins or legs extending from the rear surface and located about the first aperture; and a badge assembly having a badge portion and a mounting rim about the badge portion, the badge portion fitted up through the first aperture from the rear surface of the cover, the rim extending under the rear surface proximate the first aperture with the legs disposed in at least some corresponding mounting openings in the rim. A light source can be provided within the cover to illuminate the badge.

Many other objects and purposes of the invention will be clear from the following detailed description of the drawings.

### BRIEF DESCRIPTION OF THE DRAWINGS

FIG. 1a is an isometric view of the underside of a driver side deployment cover incorporating the present invention without a decorative emblem.

FIG. 1b is an isometric view of the top of a driver side deployment cover with the decorative emblem in place.

FIG. 2 is a plan view of the underside of the cover.

FIG. 3 is a cross-sectional view through section 3-3 of FIG. 2.

FIG. 4 shows an alternative embodiment of the invention.

FIG. 5 is a cross-sectional view through section 5-5 of FIG. 4.

FIG. 6 is a top view of a decorative badge/emblem/tag used with the present invention.

FIG. 7 is a cross-sectional view through section line 7-7 of FIG. 6.

FIGS. 8, 9 and 10 relate to alternate embodiments of the invention.

### DETAILED DESCRIPTION OF THE DRAWINGS

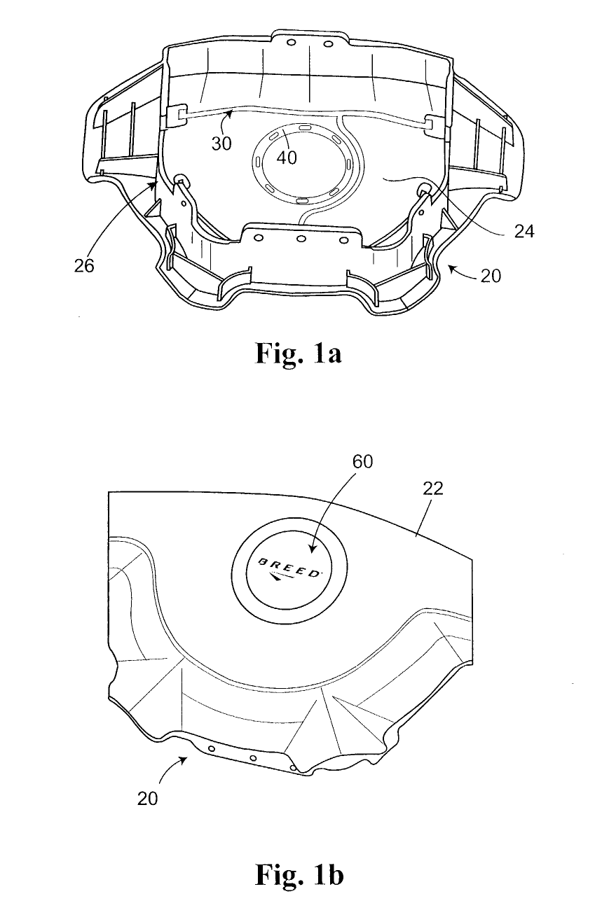

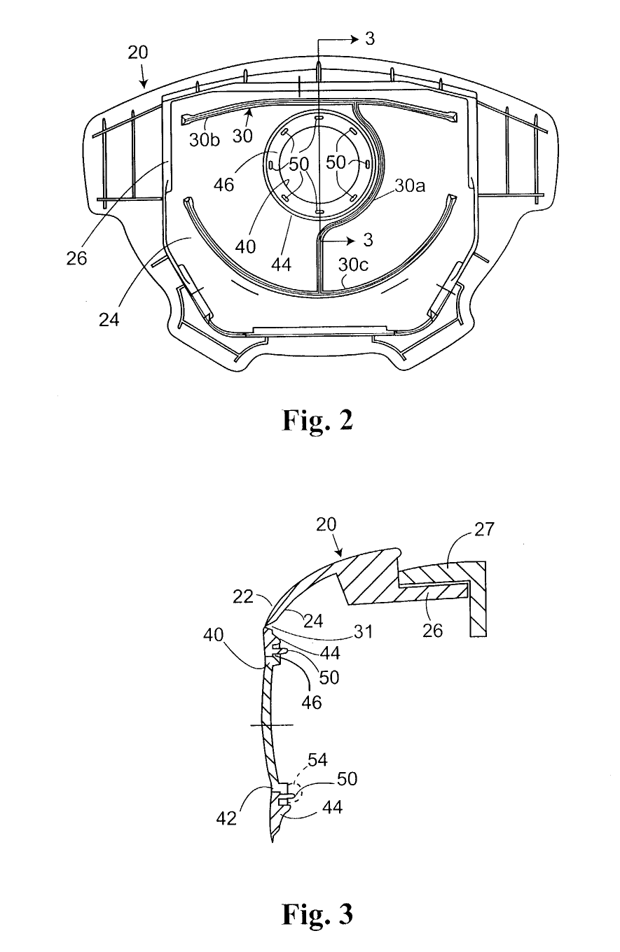

FIGS. 1-3 illustrate a first embodiment of a driver side deployment cover 20, which is part of a driver side air bag module, which typically comprises the cover, an air bag, an inflator and a housing. The cover is typically made of a molded elastomer having a top or top surface 22 and a rear, bottom or underside or surface 24. Molded into the underside (see FIGS. 1a and 3) is a plurality of secondary cover features. For example, the cover may be fabricated with a depending wall 26 (which may be in the form of a single contiguous wall or a plurality of wall segments) that has features enabling the sides to be attached to a housing 27 (see FIG. 3). These features may simply be openings through which rivets attach the sides to a complementary wall of the housing or they may include snap-fit features of known variety.

As used herein and in the claims the terms “rear,” “bottom” and “underside” are understood to refer to a surface or surfaces of an air bag cover that are hidden from view when the air bag cover is installed in its operative location in a motor vehicle. As used herein and in the claims the terms “front,” “top” and “topside” are understood to refer to a surface or surfaces of an air bag cover that are not hidden from view when the air bag cover is installed in its operative location in a motor vehicle.

The cover 20 includes one or more tear seams generally designated as numeral 30. The tear seams can include segments such as 30a, 30b and 30c, which when stressed are pushed open by the inflating air bag defining a passage through which the air bag continues to inflate. As illustrated in FIGS. 1a and 2, the tear seam 30 includes arcuate upper and lower tear seams (or seam segments) 30b and 30c. A tear seam or tear seam segment 30a connects the lower and upper tear seam segments. As is known, the tear seam provides a reduced strength portion, such as reduced thickness portion of the cover 31 (see FIG. 3), to enable the cover to tear in a controlled manner when presented with the inflating air bag. Other tear seam arrangements are within the scope of the present invention. The cover 20 includes an opening 40. As will be seen from the description below, an emblem also referred to as a tag or badge 60 (see FIG. 1b or 3) is inserted into the opening 40 from the underside of the cover 20.

As can be seen in FIG. 3, the opening 40 is defined by a walled inner or central portion 42 of the cover 20. Peripherally spaced about the opening 40 is a circular outer rim or wall 44. The thickness of the cover within the outer rim 44 can be reduced to define a recess on the underside of the cover into which the badge 60 is placed. That band or ledge portion of the cover between the outer rim and the inner wall is referred to by numeral 46. As will be seen, the dimension of the inner wall 42 and the outer rim or wall 44 correspond to mating portions of the badge or emblem 60. This rim 44 serves to properly locate the badge relative to the opening 40. It should be appreciated that while a centrally located circular opening 40 is shown, the shape of the opening (and that of the badge 60) can be any shape. Additionally, the opening can be located on virtually any portion of the cover. The opening 40 will conform to the shape of the badge, which can be varied in size and shape. Further, more than one opening can be used to accommodate badges of varying size and shape.

The underside 24 of the cover in the vicinity of the band 46 includes a plurality of integrally formed projections or tabs 50. As can be seen, these tabs 50 extend downwardly from the underside of the cover.

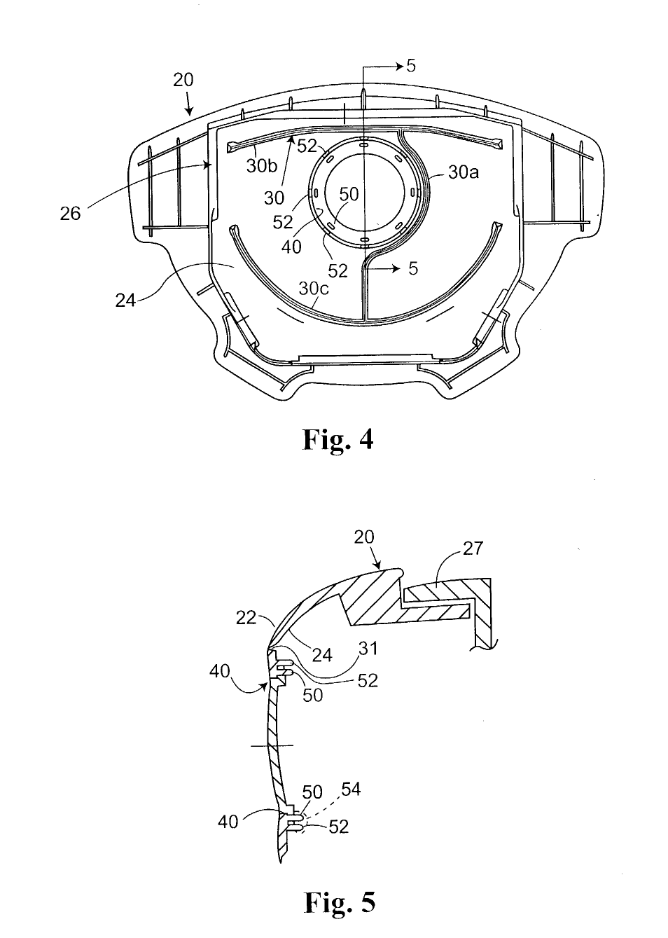

FIGS. 4 and 5 show an alternative cover 20. In this embodiment the tabs are formed in two co-axial rows of tabs, an inner row 50 and an outer row 52. Row 52 is located at the rim 44 and can be viewed as a higher or more upraised portion of the rim 44.

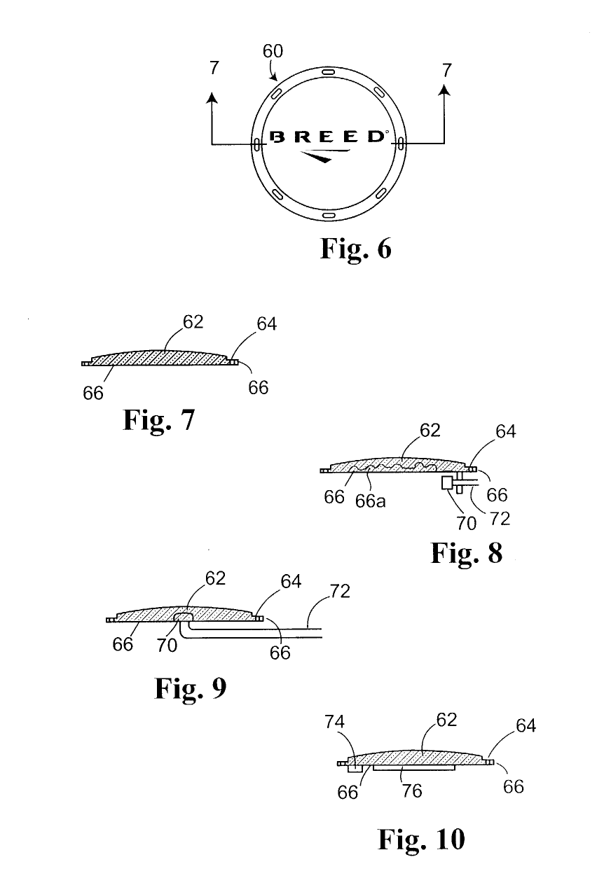

FIGS. 6 and 7 show the details of the emblem 60, which includes a center portion 62 and an outer rim 64. The center portion 62 is sized to closely fit within the opening 40. When in position on the cover 20, the emblem outer rim 64 lies upon the band 46 portion of the cover as shown for example in FIG. 3. The outer edge 66 is received within the inner surface of the rim 44. The emblem 60 includes a plurality of spaces 68. When properly positioned on the cover each of the tabs 50 (and/or tabs 52) fit within a corresponding opening or space 68. Preferably the cross-section of the openings 68 and the cross-section of the tabs 50 (and/or 52) are similar to enhance a tight fit therebetween.

The emblem 60 is secured to the cover by heat staking the tabs 50. The top of the each tab 50 will become enlarged forming a rivet-like head 54 (shown in phantom line in FIG. 3). During the heat staking an adjacent portion of the rim 44 may also be melted and may become part of the head 54. With regard to the embodiment of FIG. 4, upon each staking sets of adjacent tabs 50 and 52 in each of the inner and outer rows of tabs will be melted together to form the rivet-like head 54 shown in phantom line (see FIG. 5), which bridges an adjacent portion of the emblem.

The emblem 60 can be made from various materials and processes. Wood, metal, or plastic can be used. As previously mentioned, one of the benefits of the above construction is the emblem can be easily lit. In one embodiment the emblem can be made from a clear plastic such as Lucite. The lower surface 66 can be shaped or embossed to present a company's name, which can later be painted. However, certain portions of the emblem can be left clear. If a source of illumination such as 70 were placed under the emblem it would back light the clear portions of the emblem.

For example, FIG. 8 shows an LED 70 mechanically suspended from the rear surface 66 of the emblem 50. When electrical energy is applied to the wires 72 of the LED, it glows. Numeral 66a represents a portion of the underside of the emblem that has been embossed with a design, which can be painted and is visible from the front of the emblem; as mentioned other portions of the emblem are left undisturbed so light can shine through. FIG. 9 shows an LED 70 that has been insert molded within a light-transmissive body of the emblem. In FIG. 10 one or more layers of one or more electro-lumenescent film(s) 74 and/or 76 have been attached to the underside 66 of the emblem 50. When energized the emblem will appear to glow with one of more different colors. Additionally for the purpose of illustration numbers 74 and/or 76 can also be fiber optic cables, which can be used to illuminate the underside of the emblem 50.

Many changes and modifications in the above-described embodiment of the invention can, of course, be carried out without departing from the scope thereof. Accordingly, that scope is intended to be limited only by the scope of the appended claims.

1. An air bag cover for an inflatable air bag system comprising:
an elastomeric body having a front surface and a rear surface, the body having a first aperture extending between the front and rear surfaces and a plurality of mounting pins or legs extending from the rear surface and located about the first aperture; and
a badge assembly having a badge portion and a mounting rim about the badge portion, the badge portion fitting up through the first aperture from the rear surface, the rim extending under the rear surface proximate the first aperture with the legs disposed in at least some corresponding mounting openings in the badge rim.

2. The system as defined in claim 1 wherein the cover includes on its rear surface locating means for locating the badge assembly relative to the first aperture.

3. The system as defined in claim 1 wherein the locating means includes a plurality of wall segments.

4. The system as defined in claim 1 wherein locating means includes a singular wall.

5. The system as defined in claim 1 wherein the badge portion includes informative or decorative elements mounted in a light transmissive material.

6. The system as defined in claim 5 including lighting means for illuminating the badge portion.

7. The system as defined in claim 6 wherein the cover includes at least one light transmitting element located proximate the first aperture to shine light upon the light transmissive material.

8. The system as defined in claim 6 wherein the lighting means includes one of an LED, a fiber optic cable and an electro-luminescent layer positioned about the first aperture.

9. A method for making an air bag cover having a decorative badge secured thereto for an inflatable air bag system, the method comprising:
molding an elastomeric body having a shape defining the air bag cover;
forming at least one aperture extending through the elastomeric body and forming a plurality of legs about the first aperture which extend from an underside of the cover;
providing a badge assembly having a badge portion and a surrounding rim portion, the rim portion having a plurality of openings therethough;
inserting the badge assembly from the underside of the cover so that the badge portion enters into the first aperture with the legs extending into a corresponding opening in the rim portion
and forming on ends of selective legs a rivet head structure to hold the badge assembly to the underside of the cover.

10. The method as defined in claim 9 including the step of forming a badge locating feature on the rear surface of the cover with the badge assembly received within the locating feature.

11. The method as defined in claim 10 wherein the step of forming a rivet head structure includes melting the distal end of a leg with an adjacent portion of the locating feature.

12. The method as defined in claim 9 including the step of providing one light transmitter in the cover or on the underside of the cover proximate the first aperture.
